(19) United States
(12) Patent Application Publication
(10) Pub. No.: US 2011/0297243 A1
(43) Pub. Date: Dec. 8, 2011

(54) METHOD AND APPARATUS OF LINING A PIPE

(75) Inventor: LARRY W. KIEST, JR., Ottawa, IL (US)

(73) Assignee: LMK ENTERPRISES, INC., Ottawa, IL (US)

(21) Appl. No.: 12/792,818

(22) Filed: Jun. 3, 2010

(51) Int. Cl. F16L 55/1645

(52) U.S. Cl. 137/15.08; 138/98

(57) ABSTRACT

An apparatus and a method for using a bladder in combination with a curable material capable of curing and hardening is disclosed. A curable material capable of curing and hardening is dispensed about an interior wall of a damaged section of a pipe ahead of an inverting end of a bladder. The bladder inverts to push a plate attached to a dispensing unit, pushing the assembly through the pipe, while also compressing the curable material against the interior wall of the pipe. The material is pressed into fractures and the bladder remains inflated until the material cures and hardens, leaving a newly lined pipe. An assembly for forming the lining in the pipe includes a dispensing hose, a dispensing unit, and a bladder.

### FIELD OF THE INVENTION

The present invention relates to an apparatus and method for lining an interior surface of a pipe. More particularly, but not exclusively, the invention relates to a method and apparatus for repairing a pipe without the use of a pre-formed liner.

### BACKGROUND OF THE INVENTION

One method of repairing a damaged section of a pipe includes spraying or spin casting mortar about the interior of the pipe. The mortar will cure and harden to form a new interior wall at the damaged section of the pipe, lengthening the life of the pipe. However, many problems exist when the mortar is sprayed or spun onto the interior wall of the damaged section of a pipe.

One problem associated with this method of pipe repair is that while the mortar generally has low viscosity, gravity may cause a portion of the material to sag in the pipe before the mortar is able to fully cure. The sagging mortar will cure away from the damaged section of the wall. The sag would also cause gaps between the mortar and wall, which would allow for water penetration behind the cured mortar. The water may damage the pipe wall, and the mortar would have to be removed and reapplied.

Additionally, the sagging portion of the mortar will create new obstructions in the pipe. Merely spraying or spin casting the mortar onto the wall of the pipe would create a rough, jagged surface, which, over time, may create blockages in the pipe. Likewise, the application of the mortar by spraying or spin casting would produce a new wall of varying thickness, which would produce weak areas in the pipe.

Another method presently used for repairing pipes includes the use of a liner tube having a felt layer on its inside and having a protective layer made of polymer or other plastic material on its outside. The liner tube is vacuum-impregnated with a resin mix in what is commonly referred to as a “wet-out” process. Just prior to wetting-out the liner, a catalyst is mixed with the resin so as to activate the resin and cause it to begin curing and hardening. The resin impregnated liner tube is then inverted into the pipe so that the felt layer is inverted from the inside of the tube to the outside. Once the resin cures and hardens, the liner provides a new lining for the pipe.

One problem with the method is that the catalyst must be mixed with the resin before the liner tube is wet-out and before positioning the liner tube at the damaged section of pipe. Once the catalyst is applied to the resin, the resin begins curing and time is of the essence in order to have the liner tube in place within the pipe to be repaired. If the resin hardens before the liner tube is properly positioned within the pipe, it may require that a portion of the existing pipe be dug up and replaced. If, on the other hand, a resin mix with a longer cure time is used to ensure adequate working time to install the liner, productivity suffers as the crew waits for the liner to cure and harden.

Accordingly, there is a need in the art for an improved method and means that overcomes the problem of a damaged section of a pipe not being fully repaired by the spraying or spin casting of mortar about an interior of the damaged section of the pipe. There is also a need in the art for a method and means of repairing a damaged section of a pipe that obviates the need of a pre-formed liner.

### BRIEF SUMMARY OF THE INVENTION

It is therefore a principal object, feature, and/or advantage of the present invention to provide an improved method and means for lining a manhole which improves over or solves the deficiencies in the art.

It is another object, feature, and/or advantage of the present invention to provide an improved means and method for lining a pipe that does not require a pre-formed liner.

It is another object, feature, and/or advantage of the present invention to provide an improved means and method for lining a pipe that leaves a repaired pipe wall having a smooth surface and a uniform thickness.

It is another object, feature, and/or advantage of the present invention to provide an improved means and method for lining a pipe that penetrates damages in the pipe to prevent water from seeping into the pipe.

It is yet another object, feature, and/or advantage of the present invention to provide a method and means for lining a pipe that is more cost-effective than prior methods.

It is another object, feature, and/or advantage of the present invention to provide a method and means for repairing a pipe that is flexible in allowing any length of lining to be installed during the installation process without pre-fabrication of a liner of a desired length.

It is still another object, feature, and/or advantage of the present invention to provide an improved method and means for repairing a damaged section of a pipe that does not obstruct the normal use of the pipe.

These and/or other objects, features, and advantages of the present invention will be apparent to those skilled in the art. The present invention is not to be limited to or by these objects, features and advantages, and no single embodiment need exhibit every object, feature, and advantage.

According to one aspect of the present invention, a method of repairing a damaged section of a pipe that obviates the need for a pre-formed liner is provided. The method includes dispensing a material capable of curing about an interior wall of the pipe ahead of an inverting end of a bladder. The material is compressed against the wall of the pipe with the bladder. The material is allowed to cure, and then the bladder is removed from the pipe.

According to another aspect of the present invention, a method of repairing a damaged section of a pipe that obviates the need for a pre-formed liner is provided. The method includes positioning a bladder in the damaged section of the pipe. The bladder is inverted in the pipe. A curable material is dispensed about an interior wall of the damaged section of the pipe with a dispensing unit ahead of an inverting end of the bladder. A plate, operatively attached to the dispensing unit, is pushed with the inverting end of the bladder to move the dispensing unit along the pipe. The curable material is pressed against the wall of the pipe with an exterior surface of the bladder and the curable material is allowed to cure.

According to another aspect of the present invention, a method of repairing a damaged section of a pipe that obviates the need for a pre-formed liner is provided. A bladder, having an uneven exterior surface along the length of the bladder, is inverted into the damaged section of the pipe. A curable material is dispensed from a dispensing unit about an interior wall of the pipe ahead of an inverting face of the bladder. A plate attached to the dispensing unit is pushed with the inverting face of the bladder to move the dispensing unit along the damaged section of the pipe as the dispensing unit dispenses the curable material. The curable material is then compressed between the exterior surface of the bladder and the interior wall of the pipe, and the curable material is allowed to cure.

According to another aspect of the present invention, a liner assembly for repairing an interior of a pipe is provided. The liner assembly includes a dispensing hose, a dispensing unit, and a bladder. The dispensing unit is in fluid communication with the dispensing hose. The dispensing unit has a spinning head adapted to dispense a curable material to an interior wall of a pipe and a plate positioned forward of the spinning head. The bladder is adapted to press the curable material dispensed from the dispensing unit against the interior wall of the pipe, with the bladder having an inverting end. The inverting end of the bladder is positioned adjacent the plate of the dispensing unit such that the bladder pushes the plate and corresponding dispensing unit through the pipe as the bladder is inverted.

### BRIEF DESCRIPTION OF THE DRAWINGS

FIG. 1A is a schematic view illustrating a preferred embodiment of the present invention utilized for repairing a mainline pipe extending between two manholes.

FIG. 1B is a schematic view similar to FIG. 1A, further illustrating the preferred lining process of the present invention.

FIG. 2 is an enlarged side view of the dispensing unit for use with the preferred embodiment of the present invention.

FIG. 3 is an enlarged sectional view of a pressurized reel with bladder loaded therein for use in a preferred embodiment of the present invention.

FIG. 4 is a sectional view of a sewer pipe with a damaged section of pipe lined according to an alternative embodiment of the present invention.

FIGS. 5A-5C are enlarged sectional views, illustrating various forms of a bladder for use in an alternative embodiment of the present invention.

### DETAILED DESCRIPTION OF THE PREFERRED EMBODIMENTS

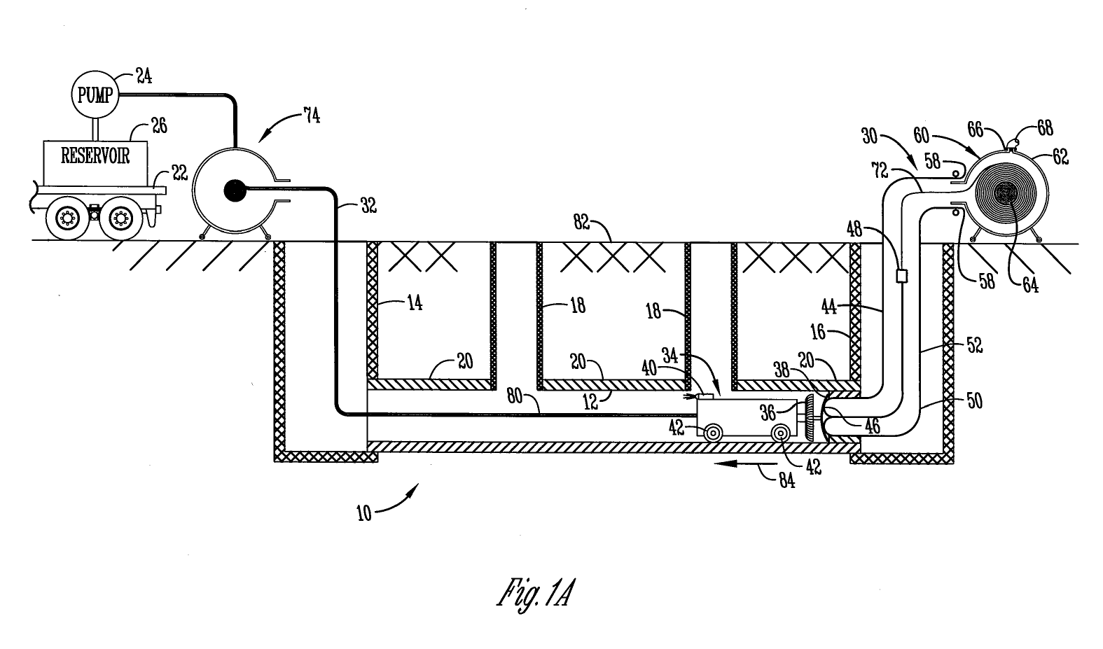

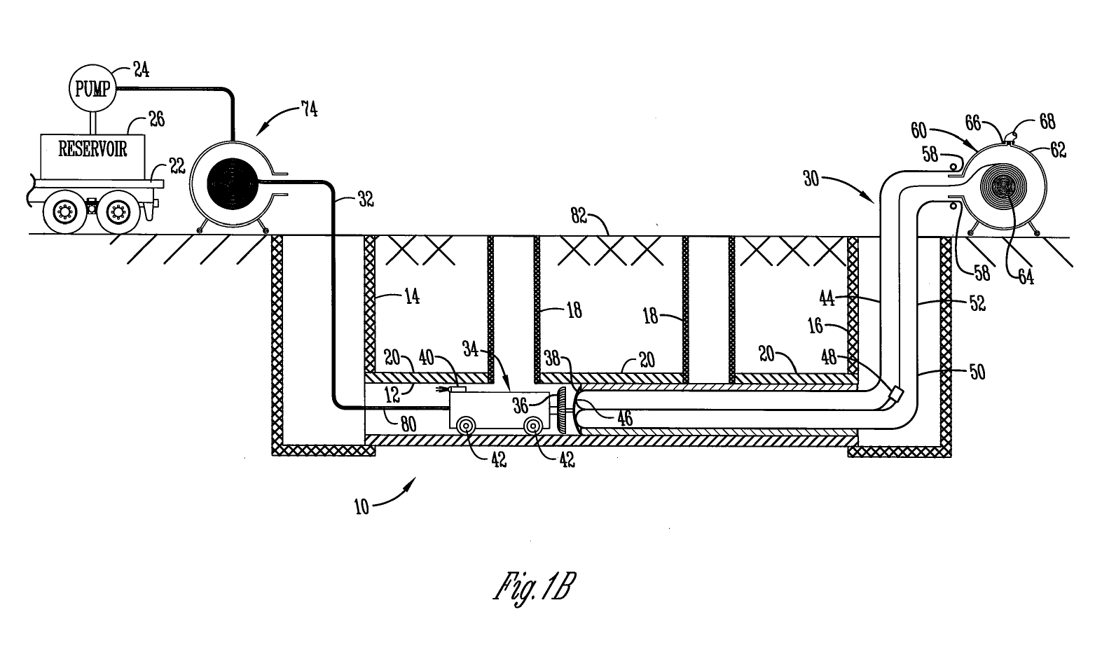

Referring to FIG. 1A, a main pipe 10 is shown extending between a downstream manhole 14 and an upstream manhole 16. Lateral pipes 18 extend from the main pipe 10 and extend through the ground 82. While the present invention is shown for use with sewer pipe repair, the present invention can be utilized for repairing other types of pipe, such as gas, water, oil, steam and compressed air pipe.

Adjacent the upstream manhole 16 is a pressurized reel 60. Inside the reel 60 is a bladder 44 connected to a rope 72. The reel 60 can be pressurized to invert the bladder 44 through the upstream manhole 16 and into the pipe 10. The bladder 44 would be inverted to a position adjacent a dispensing unit 34.

Adjacent the downstream manhole 14 on the ground 82 is a truck 22 having pump 24 and a reservoir 26 mounted thereon. Hose 32 extends from the reservoir 26 to the dispensing unit 34 shown within the pipe 10. The hose 32 may also include electronic cables for controlling the dispensing unit 34 and for transmitting images from an image device 40 operatively attached to the dispensing unit. The truck 22 also contains image receivers (not shown) for viewing data from the image device 40.

As further shown in FIG. 1A, the hose, also known as a dispensing hose 32, is wound through a take-up reel 74, which is adjacent the downstream manhole 14. The hose 32 is fluidly attached to the dispensing unit 34 located in the pipe 10, and transports a curable material 28 to the dispensing unit 34. The curable material 28 is a pumpable material capable of curing and hardening. Examples of materials that may be proper for use with the invention include mortar, grout, and modified liquid materials capable of hardening and producing high flexural and tensile properties. A preferred material for use with the present invention is Permacast, as manufactured by APM Permaform of 6843 N.W. Trail Ridge, P.O. Box 582, Johnston, Iowa 50131-0582, but other model numbers and/or manufacturers may be used as well.

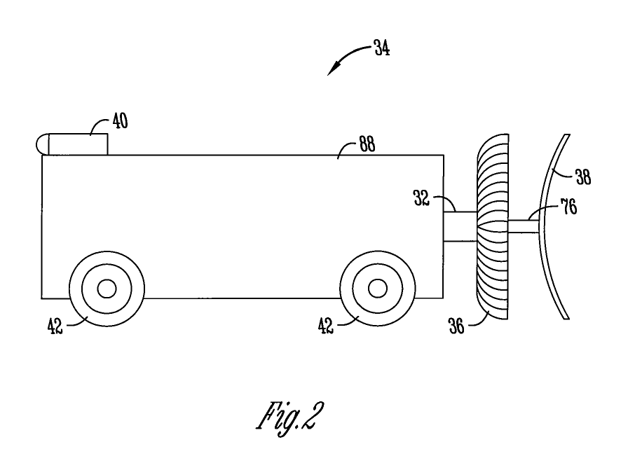

FIG. 2 is an enlarged side view of one embodiment of a dispensing unit 34 used with the present invention. The dispensing unit 34 comprises a dispensing unit housing 88 for receiving the dispensing hose 32. Attached to the dispensing housing 88 is a plurality of wheels 42 to allow the dispensing unit 34 to move through the pipe 10. An image device 40 is operatively attached to the dispensing housing 88 as well. The image device 40 is oriented rearwardly of the dispensing unit 34 to view the dispensing hose slack 80 in the pipe 10. The image device 40 is also connected to image receivers (not shown) located outside of the pipe 10, where operators can view the area rear of the dispensing unit 34 in the pipe 10.

The dispensing hose 32 extends through the dispensing unit housing 88 and is fluidly connected to a spinning device 36, which is located forward of the dispensing unit housing 88. While a spinning device 36 is shown operatively attached to the dispensing unit 34, it should be appreciated that other application methods may be used to apply the curable material 28 to the interior wall 12 of the pipe 10. Additionally, a plate 38 is attached to the dispensing unit 34 at a location forward of the spinning device 36. The plate 38 is attached to the dispensing unit housing 88 by a plate connector 76. FIG. 2 shows the plate connector 76 extending through the axis of the spinning device 36. Attaching the plate 38 in this manner will ensure that the spinning device 36 is able to sling curable material 28 about the full interior periphery of the pipe 10. However, it may be desired that the plate 38 be connected in another manner, such as below or above the edge of the spinning device 36. The plate 38 shown in FIG. 2 comprises a concave shape. However, it should be appreciated that the plate 38 be shaped in many different manners. For example, the plate 38 may be substantially straight or flat, convex, triangular, or any variation thereof. It is only required that the plate 38 be able to engage an inverting end 46 of the bladder 44 to move the dispensing unit 34 through the pipe 10.

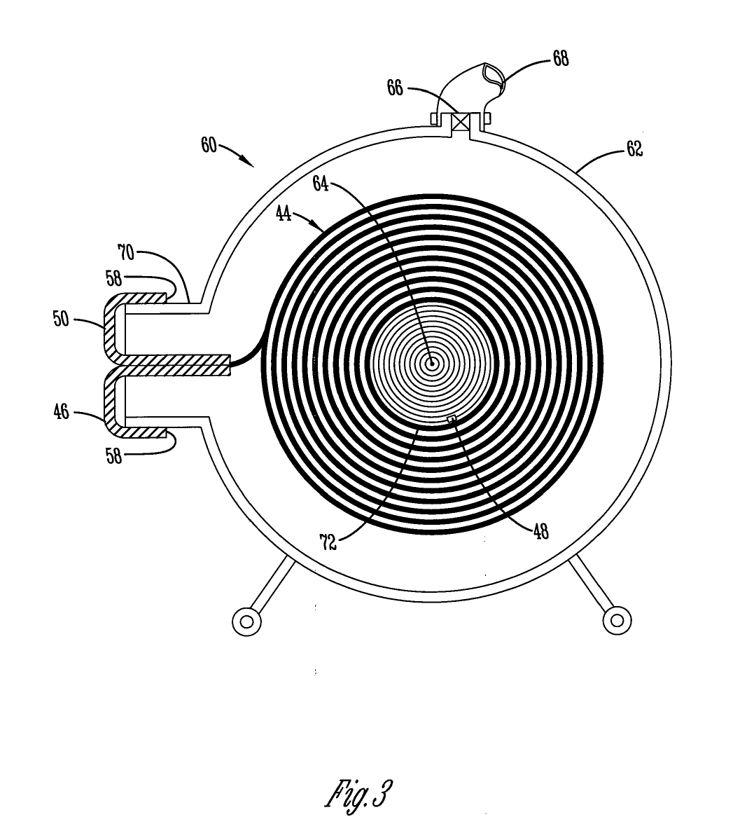

FIG. 3 is an enlarged sectional view of the pressurized reel 60 with a bladder 44 loaded therein for use in a preferred embodiment of the present invention. The pressurized reel 60 contains an outer cylindrical housing 62 and a center roller 64. A pressure inlet valve 66 in the housing 62 provides communication from the interior of the housing to a pressure hose 68. The pressure hose 68 is preferable connected to a pneumatic source of pressurized air; however, other fluids could be used without detracting from the invention. The inlet valve 66 is movable from an open position permitting pressurized fluid (preferably air) to be introduced to the interior of the pressurized reel 60 to a closed position shutting off communication of pressurized fluid from the interior of the pressurized reel 60. The reel 60 includes an inverting boss 70 on one of its sides upon which may be mounted an inflatable bladder 44.

The bladder 44 is preferably formed from a fiber reinforced non-stick plastic material, which allows the bladder 44 to be easily removed from the cured lining material 78 when re-inverted through the pipe 10. The bladder 44 preferably includes a body formed of a layer of fiber reinforcing material, such as a scrim reinforcing fabric. The layer of fiber reinforcing material is preferably a scrim of Nylon filament knit fibers. The body has an inside coating and an outside coating, both preferably made of a thermoplastic elastomer. An example of a commercial TPE elastomer alloy found suitable is Santoprene® from Exxon. The wall thickness of the bladder is preferably 15-30 mils.

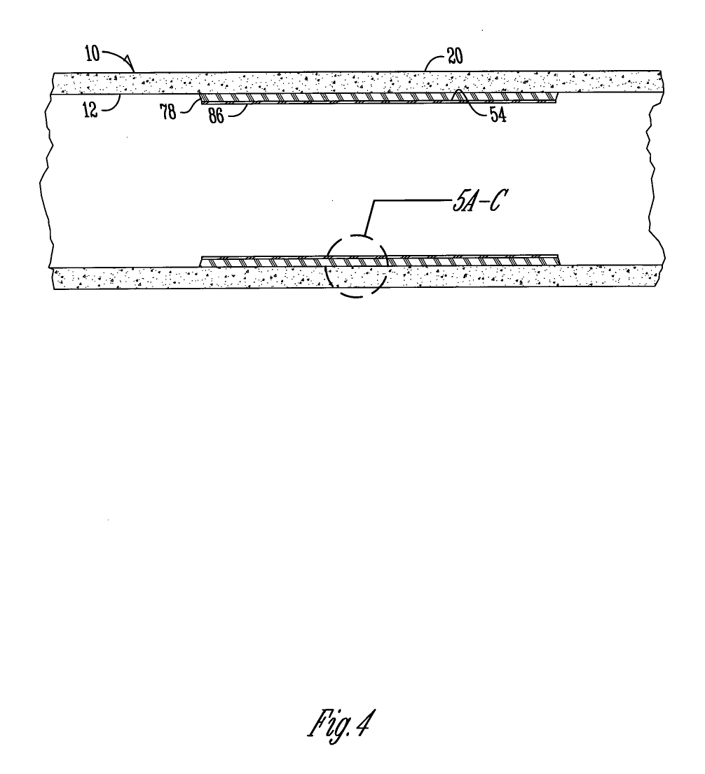

As further shown in FIG. 4, a rope 72 is wound around the center roller 64 within the pressurized reel 60. Enough rope 72 must be included to traverse the entire length of the damaged area 20 of the pipe 10 to be repaired. A closed end 48 of the bladder 44 is attached to the end of the rope 72. The bladder 44 is then wound around the center roller 64 until its complete length is taken up. The open end 58 of the bladder 44 is fitted over the boss 70 and is taped or clamped in place so as to have an airtight connection there around. As shown in FIG. 4, the open end 58 of the bladder 44 is folded back upon itself much in the same fashion s the peeling off of a sock.

Referring back to FIGS. 1A and 1B, the method of repairing a damaged section of a pipe 10 using the present invention will be described. To repair the pipe 10, the bladder 44 must be properly positioned initially relative to the dispensing unit 34. A portion of the bladder 44 is inverted and positioned in the upstream manhole 16 adjacent the opening of the pipe 10. An operator in the manhole 16 can then position the inverting end 46 of the bladder 44 against the plate 38 of the dispensing unit 34, which has been positioned in the pipe 10 through the downstream manhole 14. The inverting end 46 of the bladder should be butted against the plate 38, behind where the curable material 28 is dispensed. The pressure inlet valve 66 is moved to its open position to allow fluid pressure, preferably air, into the interior of the reel 60 such that the bladder 44 inflates and the rope 72 becomes taught. The curable material 28 is then pumped from the truck 22 through the hose 32 and is slung by the spinning device 36 about the interior wall 12 of the pipe 10.

Once an operator visually confirms that curable material 28 is dispensing through the spinning device 36, the fluid pressure in the reel 60 is increased to further inflate the bladder 44. The bladder 44 will continue to invert with the inverting end 46 of the bladder 44 pushing against the plate 38 of the dispensing unit 34, creating a liner assembly 30. The inversion of the bladder 44 against the plate 38 will push the dispensing unit 34 through the pipe 10, with the liner assembly 30 moving at substantially the same speed through the pipe 10. The liner assembly 30 essentially moves at the pace of bladder inversion. As the assembly moves through the pipe 10, the spinning device 36 will continue to sling the curable material 28 against the interior wall 12 of the pipe 10. While the bladder inverts and pushes the assembly through the pipe, operators view image data sent from the image device 40 on the dispensing unit 34 to view the dispensing hose slack 80 ahead of the dispensing unit 34. If needed, the hose 32 is pulled taught by the take-up reel 74. The use of the bladder 44 to move the assembly through the pipe 10 is beneficial to use over the use of control reels. The pushing bladder decreases the amount of devices required, and removes most of the electrical controls needed for control reels. With less parts, there is less chance of problems occurring, which helps to increase productivity of users in repairing the pipes.

As the bladder 44 inverts through the pipe 10, the exterior surface 50 of the bladder 44 will compress the curable material 28 against the wall 12 of the pipe 10 to smooth and evenly spread the material about the wall 12. The assembly will move the through the pipe 10 in the direction generally shown by the arrow 84 of FIG. 1A. Because the inverting end 46 of the bladder 44 is positioned a short distance from the spinning device 36, the exterior surface 50 of the bladder 44 will compress the curable material 28 almost instantaneously after the material has been applied to the wall 12. The almost instantaneous pressing of the bladder ensures that the material will not have an opportunity to drip or flow away from the top of the pipe, to help evenly spread the material. As the assembly moves down the pipe 10, the image device 40, oriented to a location ahead of the dispensing unit 34, will transmit image data to outside of the pipe 10. The image data will be used to determine the amount of slack 80 of the dispensing hose 32. As the slack builds up, the take-up reel 74 will be activated to reel up the excess hose 32 until the assembly reaches its end position. The image device may be a camera, but it should be appreciated to those skilled in the art that it could also be a sensor or the like.

FIG. 1A shows a small section of the curable material 28 applied to the wall 12 of the pipe 10. The instantaneous compression of the curable material 28 by the bladder 44 has many advantages. It prevents the material from sagging and running toward the bottom of the pipe 10. The compression also presses the material into fractures in the pipe 10 which stops water infiltration until the material is able to cure. Additionally, the bladder 44 ensures that the material cures into an even layer, and cures with a smooth finish for more stability and to make sure that the material has not created any blockages. The bladder is sized to create a layer of material having a predetermined thickness as well. For example, one size of pipe that may be repaired may be eight inches in diameter. A material thickness of one-quarter of an inch may be determined to be enough to fully repair the structure of the pipe. Therefore, a bladder having an inflated diameter substantially equal to seven and one-half inches would be selected to produce this thickness. Because the bladder is inflated almost instantaneously as the material is applied to the pipe wall, the material will still be viscous enough to be pressed evenly about the outer surface of the bladder to produce an even layer of material about the interior of the pipe.

FIG. 1B shows the liner assembly 30 after the bladder 44 and the dispensing unit 34 have moved along a portion of the pipe 10. The service connections to the lateral pipes 18 must be later reinstated using a robotic cutter or the like. Using a bladder 44 having a reinforced scrim, as previously described, limits the expansion of the bladder 44 when otherwise unconstrained at the lateral service connections. Once the desired length of lining has been applied to the pipe 10, the bladder 44 can stop inverting, but the pressure in the bladder 44 is maintained until the curable material 28 has fully cured and hardened. It should be appreciated by those in the art that using a material as described above will shorten the length of cure time due to the characteristics of the material. The shorter cure time will shorten the repair time and increase productivity.

In a preferred form of the invention, the bladder 44 is removed after the curable material 28 has cured and hardened. The bladder 44 is removed by pulling the rope 72, which reinverts the bladder 44. The easy removal of the bladder 44 is facilitated by the use of a non-stick bladder, as previously described. The dispensing unit 34 is also removed from the pipe 10 through the downstream manhole 14 and all of the dispensing hose 32 is reeled into the take-up reel 74.

FIG. 4 shows an alternative embodiment of the preferred lining method using a bladder 86 that is not removed from the pipe 10. In this embodiment, the exterior surface 54 of the bladder 86 is uneven or irregular in shape, which facilitates a mechanical bond between the cured material 78 and the bladder 86. FIG. 4 shows a section of the finished lining with the cured material 78 and the bladder 86. The bladder 86 has become mechanically bonded to the cured material 78 by use of various protrusions 56 located on the exterior surface 54 of the bladder 86.

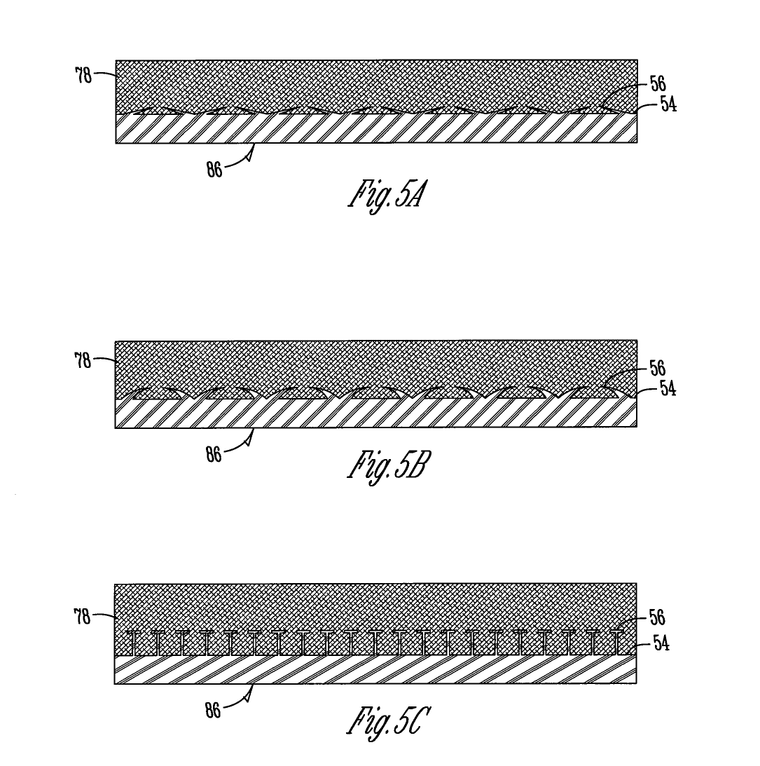

The enlarged sectional views in FIGS. 5A-5C show the exterior surface 54 of the bladder 86 including various projections 56 which can be used to physically trap the cured material 78. The hook-like projections or protrusions 56 trap the material to create a mechanical bond between the curable material and the bladder 86. The bladder 86 creates a smooth, impermeable coating for the pipe 10, which further strengthens the wall and also creates a new layer of protection against the infiltration of water into the pipe 10. Once the material has cured and hardened, a closed end 48 of the bladder 86 can be cut out to reinstate service through the pipe 10. The bladder 86 will also be cut at an open end 58 at a location near the end of the section of pipe being repaired.

The invention has been shown and described above with reference to preferred embodiments, and it is understood that modifications, substitutions, and additions may be made which are within the intended spirit and scope of the invention. The invention is only to be limited by claims appended hereto.

What is claimed is:

1. A method of repairing a damaged section of a pipe that obviates the need for a pre-formed liner, comprising:
dispensing a material capable of curing about an interior wall of the pipe ahead of an inverting end of a bladder;
compressing the material against the wall of the pipe with the bladder;
allowing the material to cure; and
removing the bladder from the pipe.

2. The method of claim 1 wherein the material is slung against the wall by a spinning device.

3. The method of claim 2 further comprising inflating the bladder to press the bladder against the material in the pipe.

4. The method of claim 3 further comprising pushing a plate operatively connected to the spinning device with the inverting end of the bladder to move the spinning device along the pipe.

5. The method of claim 1 wherein the bladder is inverted in the pipe.

6. The method of claim 1 wherein the material capable of curing is a cementious material.

7. The method of claim 1 wherein the material capable of curing is a resinous material.

8. The method of claim 1 wherein the material capable of curing is mortar.

9. The method of claim 1 further comprising viewing a dispensing hose with an image device to ensure proper slack on the dispensing hose is being retrieved.

10. The method of claim 9 where the image device is a camera.

11. The method of claim 1 wherein the bladder is a non-stick bladder which creates no bond with the material capable of curing.

12. The method of claim 1 wherein an exterior surface of the bladder being adapted to mechanically bond the material capable of curing after the material has cured.

13. A method of repairing a damaged section of a pipe that obviates the need for a pre-formed liner, comprising:
positioning a bladder in the damaged section of the pipe;
inverting the bladder in the pipe;
dispensing a curable material about an interior wall of the damaged section of the pipe with a dispensing unit ahead of an inverting end of the bladder;
pushing a plate operatively attached to the dispensing unit with the inverting end of the bladder to move the dispensing unit along the pipe;
pressing the curable material against the wall of the pipe with an exterior surface of the bladder; and
allowing the curable material to cure.

14. The method of claim 13 further comprising removing the bladder from the pipe after the curable material has cured.

15. The method of claim 13 wherein the dispensing unit is a spinning device.

16. The method of claim 15 wherein the curable material is slung about the interior wall of the pipe.

17. The method of claim 13 wherein the bladder is inverted into the pipe.

18. The method of claim 17 wherein the exterior surface of the bladder has a smooth surface for easy removal from the cured material.

19. The method of claim 13 further comprising using data sent by an image device operably attached to the dispensing unit to remove the proper amount of slack from a dispensing hose from the pipe.

20. The method of claim 13 wherein the inverting end of the bladder and the dispensing unit move through the pipe at substantially the same pace.

21. A method of repairing a damaged section of a pipe that obviates the need for a pre-formed liner, comprising:
inverting a bladder into the damaged section of the pipe, the bladder having an uneven exterior surface along the length of the bladder;
dispensing a curable material from a dispensing unit about an interior wall of the pipe ahead of an inverting face of the bladder;
pushing a plate attached to the dispensing unit with the inverting face of the bladder to move the dispensing unit along the damaged section of the pipe as the dispensing unit dispenses the curable material;
compressing the curable material between the exterior surface of the bladder and the interior wall of the pipe; and
allowing the curable material to cure.

22. The method of claim 21 further comprising removing the bladder from the pipe.

23. The method of claim 21 wherein the exterior surface of the bladder being adapted to mechanically bond the curable material to the bladder after the curable material cures.

24. The method of claim 23 wherein the exterior surface of the bladder includes projections adapted to mechanically bond the curable material to the bladder after the curable material cures.

25. The method of claim 24 wherein the exterior surface of the bladder includes hook-like projections adapted to mechanically bond the curable material to the bladder after the resin cures and hardens about the exterior surface of the bladder.

26. The method of claim 25 wherein a portion of the bladder will remain in the pipe after the curable material cures.

27. The method of claim 26 further comprising removing a closed end portion of the bladder after the curable material has cured.

28. A liner assembly for repairing an interior of a pipe, comprising:
a dispensing hose;
a dispensing unit in fluid communication with the dispensing hose, the dispensing unit having a spinning device adapted to dispense a curable material to an interior wall of a pipe and a plate positioned forward of the spinning device;
a bladder adapted to press the curable material dispensed from the dispensing unit against the interior wall of the pipe, the bladder comprising an inverting end;
wherein the inverting end of the bladder is positioned adjacent the plate of the dispensing unit such that the bladder pushes the plate and corresponding dispensing unit through the pipe as the bladder is inverted.

29. The assembly of claim 28 further comprising an image device operatively attached to the dispensing unit, the image device positioned to view an area rear of the dispensing unit.

30. The assembly of claim 28 wherein the dispensing unit and the bladder move substantially in sync with one another through the pipe.

31. The assembly of claim 28 wherein the dispensing unit further comprises a plurality of wheels adapted to allow the dispensing unit to move through the pipe.

32. The assembly of claim 28 wherein the bladder having an exterior surface being uneven and adapted to mechanically bond the curable material when the material has cured.

33. The assembly of claim 32 wherein the exterior surface of the bladder includes hook-like projections adapted to mechanically bond the curable material to the bladder after the resin cures and hardens about the exterior surface of the bladder.
